(19) United States
(12) Patent Application Publication
(10) Pub. No.: US 2016/0135606 A1
(43) Pub. Date: May 19, 2016

(54) Bunkie Bottom

(71) Applicant: Sherry Carranza, Rosenberg, TX (US)

(72) Inventor: Sherry Carranza, Rosenberg, TX (US)

(21) Appl. No.: 14/730,427

(22) Filed: Jun. 4, 2015

Related U.S. Application Data
(60) Provisional application No. 61/978,466, filed on Apr. 11, 2014.

(51) Int. Cl. A47C 21/00; B43L 5/00; A47C 19/20

(52) U.S. Cl. CPC A47C 21/00; A47C 19/20; A47C 21/003; B43L 5/00

(57) ABSTRACT

The present invention provides a device that can function as an ornamental base and mounting assembly for various gadgets and is adapted for use with a bunk bed. The device comprises a decorative, padded rigid or flexible platform with a plurality of apertures for receiving the planks of a top bunk. The platform also comprises one or more mounting points for gadgets, one or more fiber-optic lights displayed throughout the lower surface of the platform or a combination thereof. The device provides entertainment and allows users to utilize gadgets in a hands-free manner when using the bottom hunk of the bunk bed.

### CROSS-REFERENCE TO RELATED APPLICATION

This non-provisional application claims benefit of provisional application U.S. Ser. No. 61/978/466 filed on Apr. 11, 2014.

### FEDERAL FUNDING LEGEND

This invention was not created using federal funds.

### BACKGROUND OF THE INVENTION

1. Field of the Invention

The present invention generally relates to a device that is adapted for use with a bunk bed. More specifically, the present invention is directed to a platform, which is placed under the mattress of the top bunk of the bunk bed and functions as an ornamental base and a mounting assembly for various gadgets adapted for use with a hunk bed.

2. Background

A bunk bed is a highly efficient and practical way to create more space in a room. With a hunk bed, two people can sleep in the space that is normally reserved for one. While there are many different types and styles of bunk beds, most bunk beds utilize space only under the top bunk. For instance, many bunk beds do not have a bottom bunk. Instead, a couch or a desk may be placed under the to bunk. However, replacing the bottom bunk with a couch or a desk eliminates the place to sleep for the second person. Further, even where both the bunks are used to sleep, the lower surface of the top honk that faces the bottom bunk may need modifications to increase its functionality for several reasons. First, children who steep in such bunk beds may not want to read before they go to bed. Second, parents may not want their children to play video games or watch television outside their bedroom. Third, parents may want their children who are afraid to sleep alone in the dark to gaze on a soothing or beautiful design before they fall asleep. However, there are no conventional devices or methods available for increasing functionality in this manner. There has been a long-felt but unmet need to increase functionality in this manner.

Conventional devices are not designed for use with a bunk bed because they cannot be attached to the bottom of the top bunk of the bunk bed and function as a mounting assembly for various gadgets that can be used by someone sleeping in the bottom bunk. Thus, there is a significant and unmet need for a device that has plurality of apertures for receiving planks of top bunk and a mounting assembly for various gadgets and eliminates the need to replace the bottom bunk. The present invention satisfies this long standing need.

### SUMMARY OF EMBODIMENTS OF THE INVENTION

In a preferred embodiment, the present invention is directed to a device adapted for use with a bunk bed that functions as an ornamental base and/or a mounting assembly for various gadgets.

In another embodiment, such a device comprises a platform that sits within frame of a top bunk having an upper surface facing the top bunk of the bunk bed, a lower surface facing bottom bunk of the bunk bed, and a first lateral surface opposite a second lateral surface, such that the upper surface, the lower surface, the first lateral surface and the second lateral surface are aligned to form an internal volume.

In yet another embodiment, the platform described in the present invention may be rigid or flexible. In another embodiment, the platform may be made of wood, foam or a combination thereof.

In yet another embodiment, the platform comprises a plurality of apertures along length of the platform, where the apertures extend from the first lateral surface to the second lateral surface of the platform. In still yet another embodiment, these apertures are configured to receive planks that support the top bunk to the frame of the bunk bed.

In another embodiment, the lower surface of the platform may be padded to provide a cushioned surface. In yet another embodiment, the platform may be enclosed in a fabric to provide aesthetic appearance and a cushioned surface for to user of the bunk bed. In still yet another embodiment, the platform may also comprise one or more fiber-optic lights displayed throughout the lower surface such that the light is seen coming through the fabric.

In another embodiment, the lower surface of the rigid platform may comprise one or more mounting points for gadgets, where the mounting points support a monitor of the gadget in a fixed position on the lower surface, a monitor of the gadget with fold down capability from the lower surface, a drop down piece or a combination thereof. In yet another embodiment, examples of gadgets that are mounted on the lower surface may include but are not limited to a dry erase board, multimedia device, a DVD console, a game console or a combination thereof. In yet another embodiment, examples of the multimedia device may include but are not limited to wireless capability or internet capability. In still yet mother embodiment, examples of the multimedia device may include but are not limited to one or more built-in ports for headphones, controllers, MP3 players or a combination thereof. In another embodiment, the dry-erase board mounted on the lower surface may include but is not limited to a glow in the dark dry-erase board.

### BRIEF DESCRIPTION OF THE DRAWINGS

FIG. 1 shows an expanded view of one example of the present invention as installed.

FIG. 2 shows the platform described in the present invention covered with fabric.

FIGS. 3A-D show different embodiments of the present invention that increase the functionality of the bunk bed.

FIG. 4 shows a view of one example of a lighting feature of the present invention.

FIG. 5 shows a view of one embodiment of the present invention as used with a dry erase hoard.

FIG. 6 shows a view of one embodiment of the present invention as used with a video game console and a dry-erase board.

FIG. 7 shows a close up view of another embodiment of a video game console and a drop-down piece as installed according to the preset invention.

### DETAILED DESCRIPTION

The present is directed to a platform that sits within the frame of the top bunk bed and provides entertainment options to the user of the bottom bunk. This platform may be rigid or flexible. It may or may not be padded. Further, it may or may not be covered by decorative fabric.

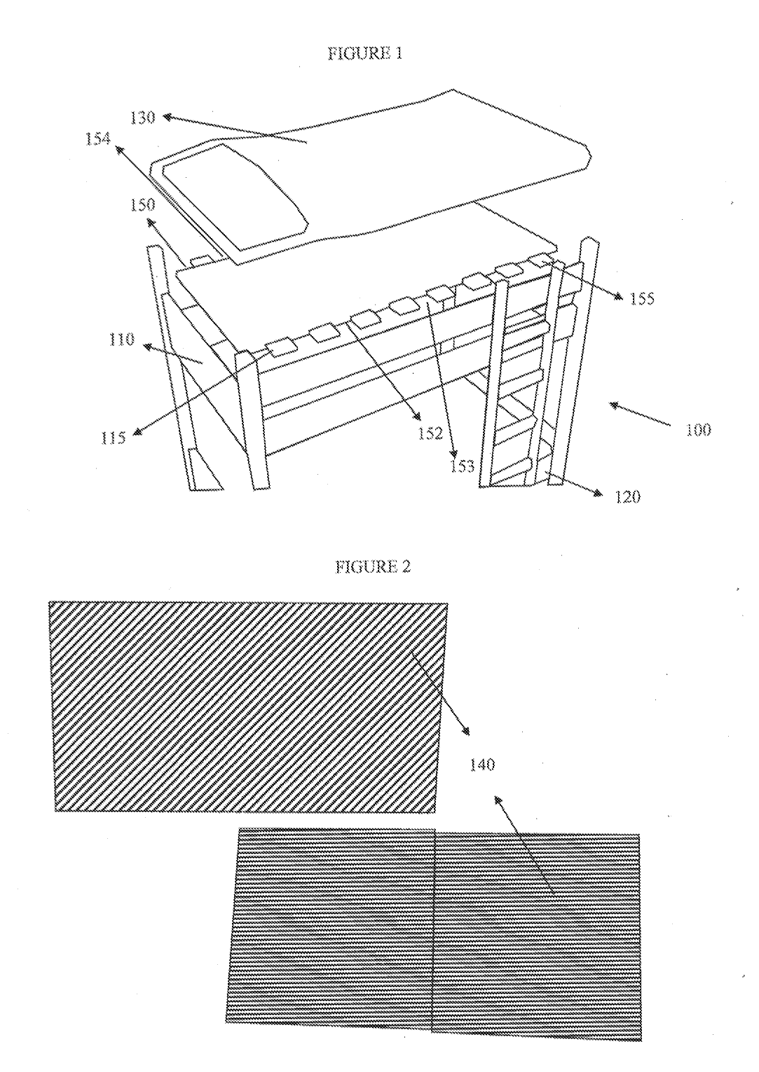

FIG. 1 shows one example of a preferred embodiment of the present invention as installed. As shown in FIG. 1, the bunk bed 100 comprises a top bunk 110 and a bottom bunk 120. The platform 150 described in the present invention is placed under mattress 130 of the top bunk. This platform 150 has an upper surface 151, a lower surface 152, a first lateral surface 153 and a second lateral surface 154; all of these surfaces are aligned in a manner to form an internal volume. The platform 150 comprises a plurality of apertures 155 along its length, where the apertures 155 extend from the first lateral surface 153 to the second lateral surface 154. The apertures 155 may be configured to receive planks 115 that support the top bunk 110 and may be situated underneath the mattress 130 of the top bunk 110 and facing the person on the bottom bunk 120. In other words, the planks 115 that support the top bunk 110 may be inserted through the apertures 155 located on the platform 150 along its length. Thereafter, the platform 150 and the planks 115 are placed on the top bunk 110 with the lower surface 152 of the platform 150 facing the bottom bunk 120. When the platform 150 and the planks 115 are securely placed, the top bunk mattress 130 may be placed thereon. Although the exact specifications of the platform 150 including but not limited to its height, width, length and shape may vary upon manufacturing, the platform 150 may approximately measure 2-3 inches in height, 74 inches in length and 37.5 inches in width. In another embodiment, the platform 150 may be rigid or flexible. In yet another embodiment, the materials used to make the platform 150 may include but are not limited to wood, foam, or a combination thereof.

FIG. 2 shows another embodiment in which the platform is enclosed in fabric 140 to provide an aesthetic appearance and a cushioned surface for a user. In yet another embodiment, the lower surface 152 of platform 150 may be padded to provide a cushioned surface to protect a person from accidentally bumping their head.

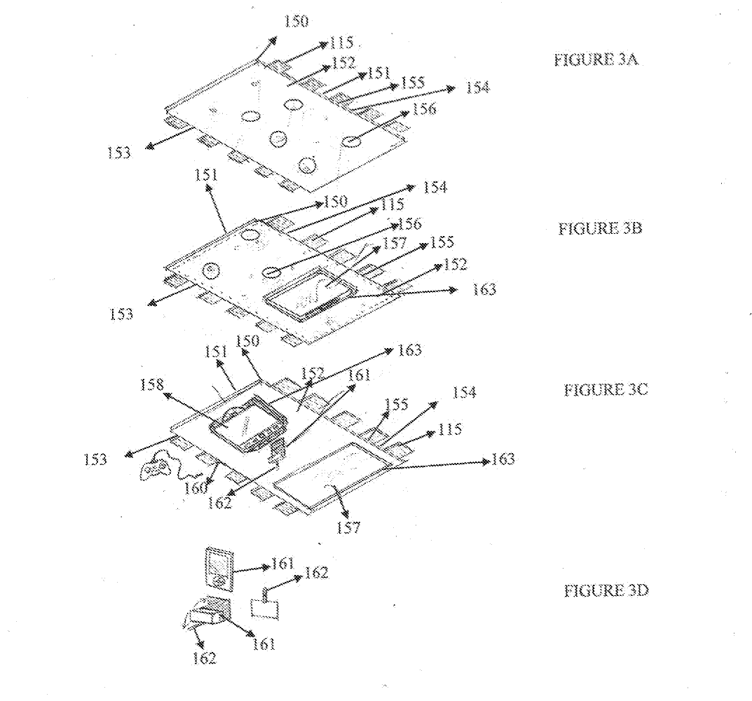

FIGS. 3A-3D show embodiments in which platform 150 of the present invention is modified to increase the functionality of the bunk bed. FIG. 3A shows one embodiment in which the platform 450 may include one or more fiber-optic lights 156 displayed throughout the lower surface 152 so that the light is shown through the fabric. FIG. 3B shows another embodiment in which a dry erase board 157 may be mounted on a mounting point 163 on the lower surface 152 of platform 150. FIG. 3C shows yet another embodiment in which a console 158, for instance a DVD console, a game console or a combination thereof may be mounted on a mounting point 163 on the lower surface 152 of platform 150. In still yet another embodiment as shown in FIG. 3C, the platform may comprise one or more outlets 160 for game controllers 171 on the lower surface 152. In another embodiment as shown in FIG. 3C, the lower surface 152 of platform 150 may further comprise a drop down piece 161 with a lever 162 to mount gadgets on the lower surface 152. FIG. 3D shows exploded view of the drop down piece 161 which has a lever 162 to pull it down.

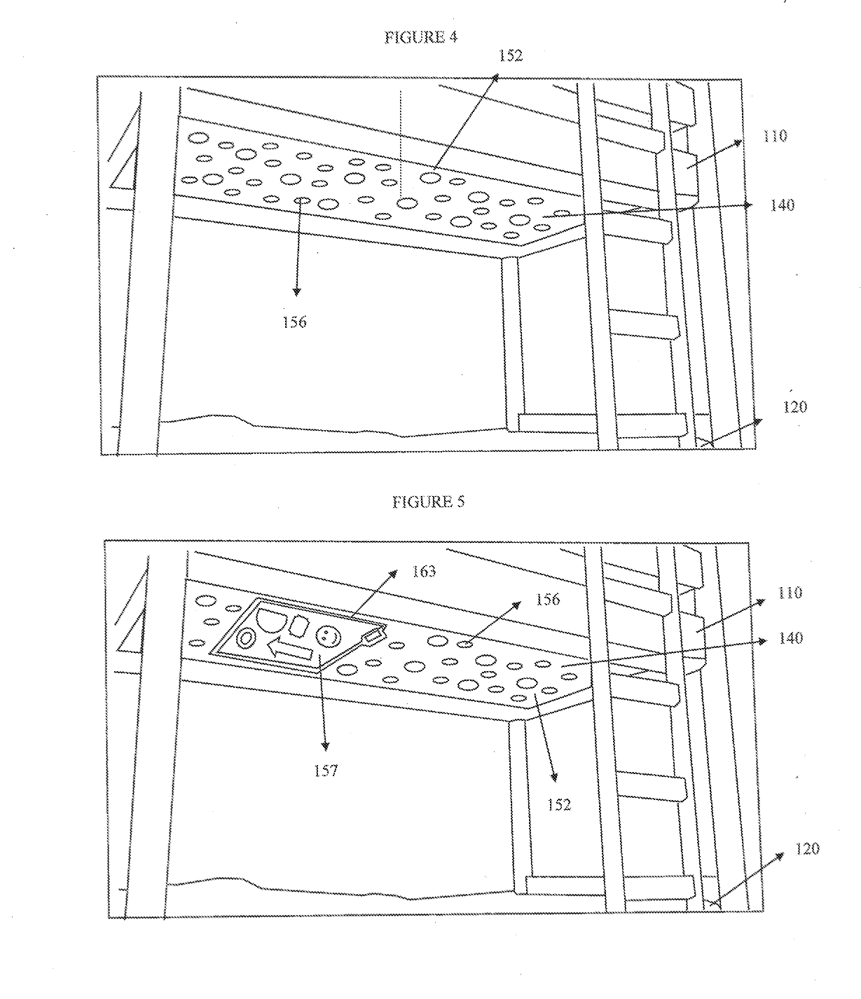

FIG. 4 shows a preferred embodiment, wherein the lower surface 152 of platform 150 is enclosed with fabric 140 and has fiber optic lights 156 for aesthetic appearance displayed throughout the lower surface 152.

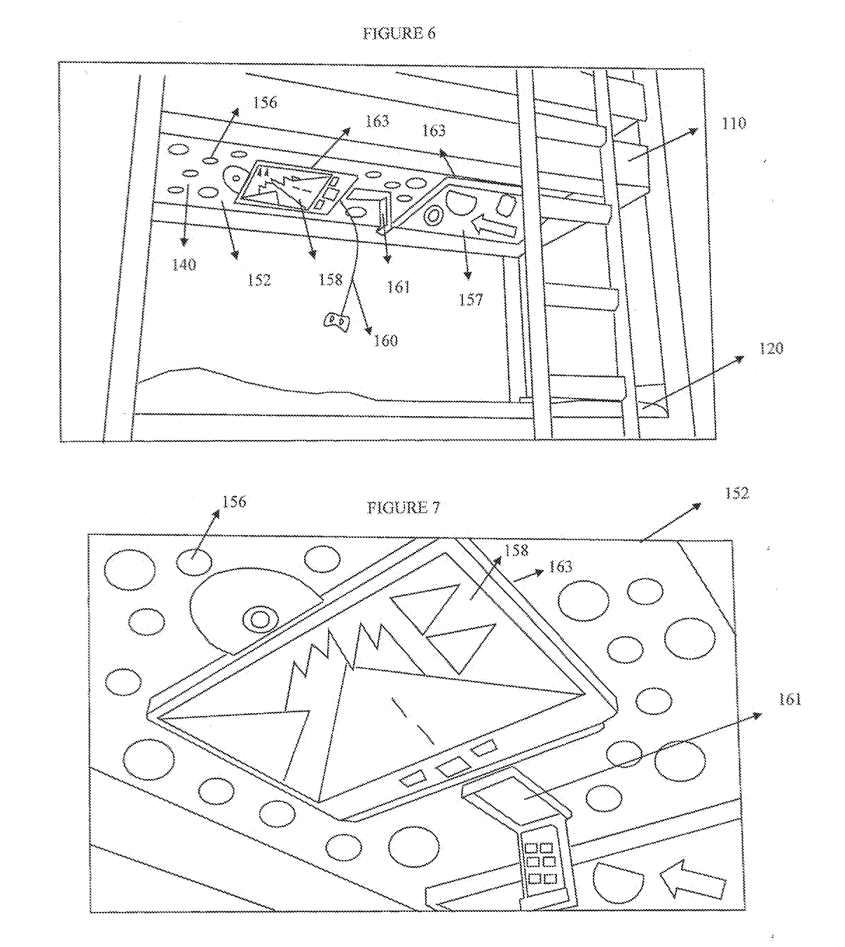

FIGS. 5-7 show embodiments, wherein one or more gadgets are mounted on the mounting point 163 on the lower surface 152 of platform 150. Preferably, the dry erase board 157 is mounted on mounting point 163 on the lower surface 152 of platform 150 as shown in FIG. 5. FIG. 6 shows a console 158, for instance a game console, mounted on mounting point 163 on the lower surface 152 of platform 150. Preferably, the lower surface 152 of platform 150 also comprises one or more outlets 160 for game controllers 171 as shown in FIG. 6. FIG. 6 also shows another embodiment, wherein a drop down piece 161 is mounted on mounting point 163 on the lower surface 152 of platform 150. FIG. 7 shows a console 158, for instance a game console and drop down piece 161 as mounted on mounting points 163 on the lower surface 152 of platform 150. Preferably, the fold down piece 161 is used as a mounting dock for MP3, Iphone, etc.

The platform 150 described in the present invention increases the functionality of the bunk bed 100 without compromising the use of the bottom bunk 120. It allows for the bottom bunk 120 of the bunk bed 100 to be functionally customized. It also eliminates boredom with glow in the dark dry-erase board 157 and digital gadgets mounted on the platform 150 and which may have fold-down capability. The platform 150 may have different colors, sizes and shapes. One example of shape of platform 150 is shown in FIG. 3A. Other representing shapes of the platform 150 may be oval, elliptical, square, etc. With regards to color of the platform, the platform may be designed so that it has one color, plurality of colors or a mixture of colors. By covering the lower surface 152 with fabric 140 having design and mounting gadgets, the platform 150 will comfort a child who might be otherwise afraid to sleep in the dark. It is easy to use because the platform 150 attaches directly to the top bunk 110. The padded design of the platform protects the user of the bottom bunk from bumping his head.

As used herein, the tem “apertures” is understood in the art to mean openings along the length of the platform 150, wherein such openings include hut are not limited to holes, slits, cracks or gaps that are configured to receive planks 115 that support the top bunk 110.

As used herein, the term “cushioned surface” is understood in the art to mean a surface that resembles a cushion, which may be a soft pad or case filled with soft material that protects body or parts of it from getting hurt.

As used herein, the term “fiber-optic lights” may include single lights or strands of light.

As used herein the term “mounting points” refers to a preferred mechanism for attaching, affixing, or supporting one or more gadgets to the lower surface 152 of platform 150.

As used herein, the term “gadget” is understood in the art to mean a mechanical or electronic device.

As used herein, the term “console” comprises controlling unit and monitors of a video game, a DVD player or other similar gadgets.

As used herein, the term “internet” is understood in the art to mean a network of computers that links smaller computer networks worldwide. It includes and is not limited to commercial, educational, or governmental networks.

The foregoing descriptions of the embodiments of the present invention have been presented for purposes of illustration and description. They are not intended to be exhaustive or to limit the present invention to the precise forms disclosed. The exemplary embodiments were chosen and described in order to best explain the principles of the present invention and its practical application, to thereby enable others skilled in the art to best utilize the present invention.

What is claimed is:

1. A device adapted for use with a bunk bed that functions as an ornamental base and a mounting assembly for various gadgets, comprising:
platform that sits within the frame of a top bunk having an upper surface facing said top bunk, a lower surface facing bottom bunk, and a first lateral surface opposite a second lateral surface such that said upper surface, said lower surface, said first lateral surface and said second lateral surface are aligned to form an internal volume.

2. The device of claim 1, wherein said platform is rigid or flexible.

3. The device of claim 1, wherein said platform is made of wood, foam or a combination thereof.

4. The device of claim 1, wherein said platform comprises a plurality of apertures along the length of said platform, wherein said apertures extend from said first lateral surface to said second lateral surface of said platform.

5. The device of claim 4, wherein said apertures are configured to receive planks that support the top bunk to frame of said bunk bed.

6. The device of claim 1, wherein said lower surface of said platform is padded to provide a cushioned surface.

7. The device of claim 1, wherein said platform is enclosed in fabric to provide aesthetic appearance and as cushioned surface for a user.

8. The device of claim 7, wherein said platform comprises one or more fiber-optic lights displayed throughout the lower surface such that said light is seen through said fabric.

9. The device of claim 1, wherein said lower surface of said platform comprises one or more mounting points for gadgets, wherein said mounting points support
a monitor of said gadget in a fixed position on the lower surface,
a monitor of said gadget with a fold down capability from the lower surface,
a drop down piece, or
a combination thereof.

10. The device of claim 9, wherein said gadget mounted on said lower surface comprises a dry erase board, a multimedia device, a DVD console, a game console or a combination thereof.

11. The device of claim 10, wherein said multimedia device comprises wireless capability or interact capability.

12. The device of claim 10, wherein said multimedia device comprises one or more built-in ports for headphones, controllers, MP3 players or a combination thereof.

13. The device of claim 10, wherein said dry-erase board is a glow in the dark dry-erase board.
